(19) United States
(12) Patent Application Publication
(10) Pub. No.: US 2019/0134980 A1
(43) Pub. Date: May 9, 2019

(54) LIQUID JET HEAD AND LIQUID JET RECORDING DEVICE

(71) Applicant: SII Printek Inc., Chiba-shi (JP)

(72) Inventors: Shunsuke YAMAZAKI, Chiba-shi (JP); Naohiro TOMITA, Chiba-shi (JP); Masaru MIDORIKAWA, Chiba-shi (JP); Yuki YAMAMURA, Chiba-shi (JP); Shuji SATO, Chiba-shi (JP)

(21) Appl. No.: 16/181,869

(22) Filed: Nov. 6, 2018

(30) Foreign Application Priority Data
Nov. 8, 2017 (JP) 2017-215258

(51) Int. Cl. B41J 2/14

(52) U.S. Cl. CPC B41J 2/1433

(57) ABSTRACT

There is provided a liquid jet head which makes it possible to stably manufacture the liquid jet head having an excellent jet characteristic. The liquid jet head is provided with a head chip including an actuator plate having a plurality of channels which is filled with liquid, and a nozzle plate attached to the actuator plate and having a plurality of nozzle holes from which the liquid filled in the plurality of channels is jetted, and a flow channel member fixed along the head chip, having a flow channel of the liquid to be supplied to the plurality of channels, and being higher in rigidity than the head chip.

### RELATED APPLICATIONS

This application claims priority under 35 U.S.C. § 119 to Japanese Patent Application No. 2017-215258 filed on Nov. 8, 2017, the entire content of which is hereby incorporated by reference.

### BACKGROUND OF THE INVENTION

### 1. Field of the Invention

The present disclosure relates to a liquid jet head for jetting a liquid, and a liquid jet recording device using the liquid jet head.

### 2. Description of the Related Art

As a recording device for recording an image, and so on, on a recording target medium, there is known a liquid jet recording device equipped with a liquid jet head.

In the liquid jet recording device, a liquid is jetted from the liquid jet head to the recording target medium to thereby record an image, and so on, on the recording target medium.

Regarding the configuration of the liquid jet recording device, there have been made a variety of studies. Specifically, in order to downsize an inkjet device of a type of circulating ink, there is used an inkjet device equipped with a manifold together with an actuator (see, e.g., JP-A-2016-094014).

Although a variety of studies have been made regarding the configuration of the liquid jet recording device equipped with the liquid jet head, the jet characteristic and the manufacturing stability of the liquid jet head are not yet sufficient, and therefore have room for improvement.

Therefore, it is desired to provide a liquid jet head and a liquid jet recording device which make it possible to stably manufacture the liquid jet head. having an excellent jet characteristic.

### SUMMARY OF THE INVENTION

A liquid jet head according to an embodiment of the disclosure is provided with a head chip including an actuator plate having a plurality of channels which is filled with liquid, and a nozzle plate attached to the actuator plate and having a plurality of nozzle holes from which the liquid filled in the plurality of channels is jetted, and a flow channel member fixed along the head chip, having a flow channel of the liquid to be supplied to the plurality of channels, and being higher in rigidity than the head chip.

A liquid jet recording device according to an embodiment of the disclosure is provided with a liquid jet head adapted to jet a liquid to a recording target medium, and a liquid storage section adapted to store the liquid, and the liquid jet head has substantially the same configuration as that of the liquid jet head according to the embodiment of the disclosure described above.

According to the liquid jet head and the liquid jet recording device of the embodiment of the present disclosure, since the flow channel member is higher in rigidity than the head chip, and the flow channel member is fixed along the head chip, it is possible to stably manufacture the liquid jet head having the excellent jet characteristic and the liquid jet recording device equipped with the liquid jet head.

### BRIEF DESCRIPTION OF THE DRAWINGS

FIG. 1 is a perspective view showing a configuration of a liquid jet recording device (a liquid jet head) according to an embodiment of the disclosure.

FIG. 2 is a plan view schematically showing a configuration of the liquid jet head shown in FIG. 1.

FIG. 3 is a diagram schematically showing a configuration of the circulation mechanism shown in FIG. 1.

FIG. 4 is a perspective view showing respective configurations of the nozzle plate, the actuator plate, and the cover plate shown in FIG. 2.

FIG. 5 is a plan view showing a configuration of the actuator plate shown in FIG. 4.

FIG. 6 is a cross-sectional view showing respective configurations of the nozzle plate, the actuator plate, and the cover plate along the line A-A shown in FIG. 5.

FIG. 7 is a plan view showing a configuration of the flow channel plate shown in FIG. 2.

FIG. 8 is a plan view for explaining a configuration and a problem of a liquid jet recording device (a liquid jet head) of a comparative example.

FIG. 9 is a plan view for explaining an advantage of the liquid jet recording device (the liquid jet head) according to the embodiment of the disclosure.

FIG. 10 is a plan view showing a modified example related to the configuration of the liquid jet head according to the embodiment of the disclosure.

### DETAILED DESCRIPTION OF THE PREFERRED EMBODIMENTS

An embodiment of the present disclosure will hereinafter be described in detail with reference to the drawings. It should be noted that the order of the descriptions is as follows.

1. Liquid Jet Recording Device (Liquid Jet Head)
1-1. Respective Configurations of Liquid Jet Recording Device and Liquid Jet Head
1-2. Respective Detailed Configurations of Nozzle Plate, Actuator Plate and Cover Plate
1-3. Detailed Configuration of Flow Channel Plate
1-4. Operations
1-5. Functions and Advantages

2. Modified Examples

### 1. Liquid Jet Recording Device (Liquid Jet Head)

A liquid jet recording device of an embodiment of the present disclosure will be described.

It should he noted that the liquid jet head of the embodiment of the present disclosure is a part of the liquid jet recording device described here, and therefore, the liquid jet head will also be described below.

### <1-1. Respective Configurations of Liquid Jet Recording Device and Liquid Jet Head>

Firstly, the respective configurations of the liquid jet recording device and the liquid jet head will be described.

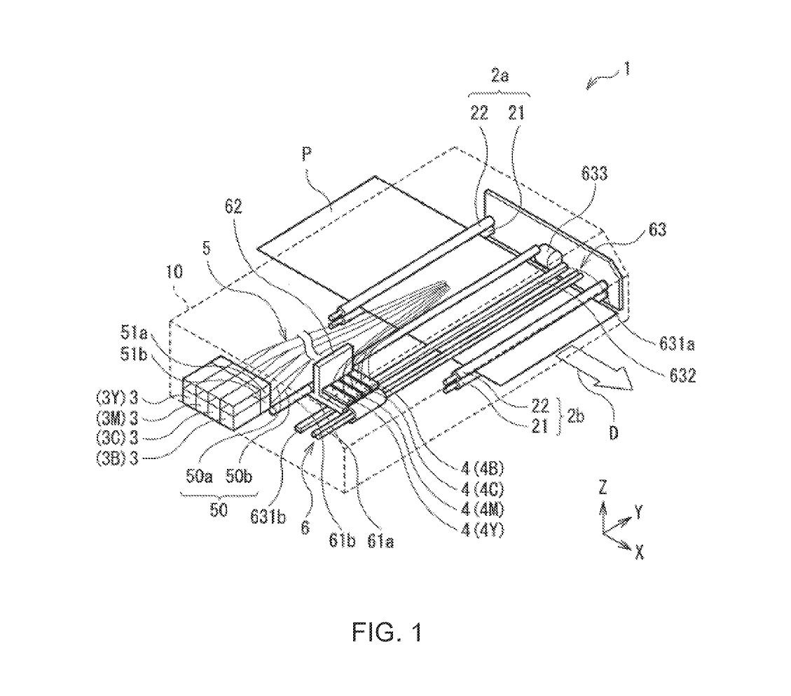

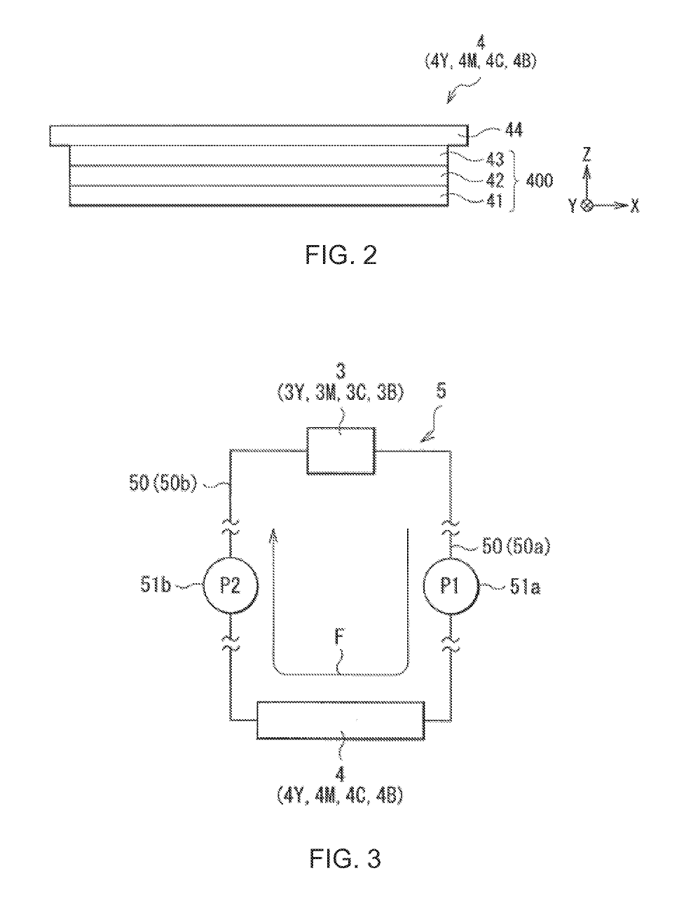

FIG. 1 shows a perspective configuration of a printer 1 as a specific example of the liquid jet recording device. FIG. 2 schematically shows a planar configuration of an inkjet head 4 as a specific example of the liquid jet head shown in FIG. 1. FIG. 3 schematically shows a configuration of the circulation mechanism 5 shown in FIG. 1. It should be noted that in FIG. 1, the inside of a housing 10 is shown by representing an outer edge (contour) of the housing 10 using dotted lines.

This printer 1 is an inkjet type printer for mainly recording (printing) an image, and so on, on recording paper P as a recording target medium using ink 9 as liquid for recording described later, and is a so-called inkjet printer.

In particular, the printer 1 described here is an inkjet printer of an ink circulation type using the ink 9 circulating in, for example, the circulation mechanism 5.

Specifically, as shown in FIG. 1 through FIG. 3, the printer 1 is provided with a pair of carrying mechanisms 2a, 2b, ink tanks 3, inkjet heads 4, a circulation mechanism 5, and a scanning mechanism 6 disposed inside the housing 10.

It should be noted that in FIG. 1 through FIG. 3 and the drawings described later, the scale size of each of the constituents is arbitrarily changed in order to convert the sizes of a series of constituents related to the printer 1 into recognizable sizes.

### [Carrying Mechanisms]

The pair of carrying mechanisms 2a, 2b are each a mechanism for mainly carrying the recording paper P having loaded into the printer 1 in a carrying direction D (an X-axis direction).

The carrying mechanisms 2a, 2b each include a grit roller 21 and a pinch roller 22 as shown in, for example, FIG. 1. The grit rollers 21 and the pinch rollers 22 each extend in, for example, a direction (a Y-axis direction) crossing the carrying direction D, and are each rotatable around the rotational axis extending in that direction. Further, the carrying mechanisms 2a, 2b are each connected to a drive mechanism such as a motor not shown, and each rotate using the power of the drive mechanism.

Here, the planar shape of the recording paper P is, for example, a rectangular shape defined by a pair of long sides opposed to each other, and a pair of short sides opposed to each other. Due to this configuration, the carrying direction D is, for example, a direction (the X-axis direction) along the longitudinal direction of the recording paper P, and at the same time, the direction crossing the carrying direction D is, for example, a direction (the Y-axis direction) along the short-side direction of the recording paper P.

### [Ink Tanks]

The ink tanks 3 are each a liquid storage section for mainly storing the ink 9.

The number of the ink tanks 3 is not particularly limited, and can therefore be just one, or two or more. Here, the printer I is provided with, for example, the four ink tanks 3 (3Y, 3M, 3C and 3B) for containing the ink 9 different in color from each other as shown in FIG. 1. The ink tanks 3Y, 3M, 3C and 3B are arranged in this order in, for example, the carrying direction D (the X-axis direction) from the upstream side toward the downstream side.

The ink tank 3Y stores, for example, the yellow (Y) ink 9. The ink tank 3M stores, for example, the magenta (M) ink 9. The ink tank 3C stores, for example, the cyan (C) ink 9. The ink tank 3Y contains, for example, the black (B) ink 9.

The ink tanks 3Y, 3M, 3C and 3B have substantially the same configurations except, for example, the fact that the types (colors) of the ink 9 are different from each other. Hereinafter, the ink tanks 3Y, 3M, 3C and 3B are collectively referred to as the “ink tanks 3” if necessary.

[Inkjet Heads]

The inkjet heads 4 are each a device (head) for jetting the ink 9 to the recording paper P in order to mainly record an image, and so on, on the recording paper P. In this inkjet head 4, in particular, the ink 9 having a droplet form is jetted to the recording paper P.

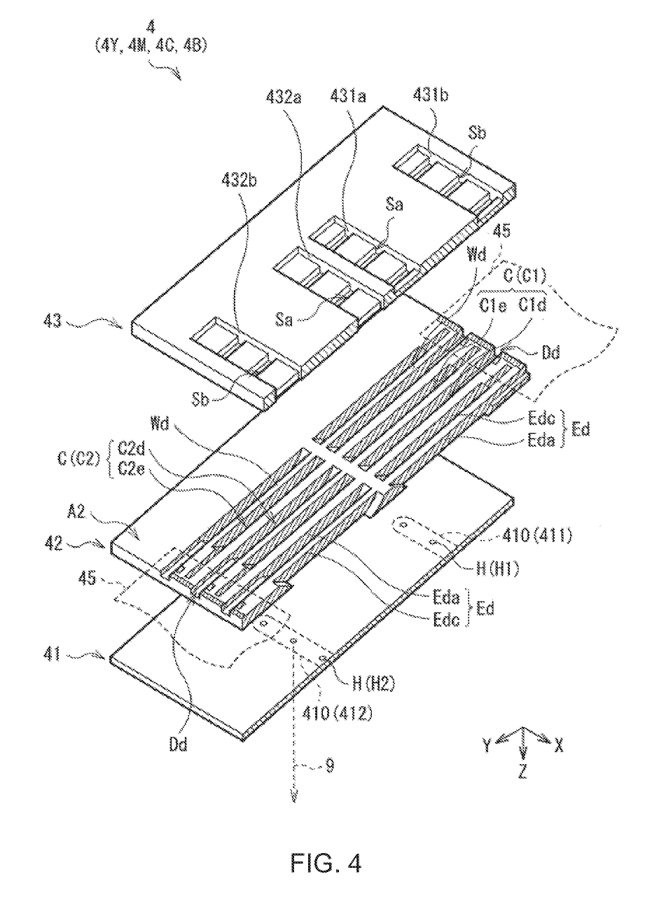

The inkjet head 4 described here is, for example, the inkjet head 4 of a so-called side-shoot type, and jets the ink 9 from a roughly central area of each of channels C (see FIG. 4 through FIG. 6) described later. Specifically, in the inkjet head 4 of the side-shoot type, as described later, the channels C provided to an actuator plate 42 extend in the Y-axis direction, and the ink 9 is jetted from each of nozzle holes H provided to a nozzle plate 41 in a Z-axis direction crossing the Y-axis direction.

Further, the inkjet head 4 is, for example, a so-called circulation type inkjet head 4, and uses the ink 9 circulated between the ink tank 3 and the inkjet head 4 using the circulation mechanism 5 described above.

Specifically, as shown in FIG. 2, the inkjet head 4 includes a head chip 400 and a flow channel plate 44. The flow channel plate 44 is, for example, a plate-like flow channel member. The head chip 400 and the flow channel plate 44 each extend in, for example, a predetermined direction (the X-axis direction). The head chip 400 extends along one of the surfaces of the flow channel plate 44, and is fixed to the one of the surfaces of the flow channel plate 44 at the same time.

The head chip 400 includes, for example, the nozzle plate 41, the actuator plate 42 and a cover plate 43. The nozzle plate 41, the actuator plate 42 and the cover plate 43 are stacked on one another in this order, the nozzle plate 41 being the furthest from the flow channel plate 44.

The number of the inkjet heads 4 is not particularly limited, and can therefore be just one, or two or more. Here, the printer 1 is provided with, for example, the four inkjet heads 4 (4Y, 4M, 4C and 4B) for jetting the ink 9 different in color from each other in accordance with the four ink tanks 3 (3Y, 3M, 3C and 3B) described above as shown in FIG. 1. The inkjet heads 4Y, 4M, 4C and 4B are arranged in this order in, for example, a direction (the Y-axis direction) crossing the carrying direction D.

The inkjet head 4Y jets, for example, the yellow ink 9. The inkjet head 4M jets, for example, the magenta ink 9. The inkjet head 4C jets, for example, the cyan ink 9. The inkjet head 4B jets, for example, the black ink 9.

The inkjet heads 4Y, 4M, 4C and 4B have substantially the same configurations except, for example, the fact that the types (colors) of the ink 9 are different from each other. Hereinafter, the inkjet heads 4Y, 4M, 4C and 4B are collectively referred to as the “inkjet heads 4” if necessary.

It should be noted that the detailed configuration of the inkjet head 4 (the nozzle plate 41, the actuator plate 42, the cover plate 43 and the flow channel plate 44) will be described later (see FIG. 4 through FIG. 7).

### [Circulation Mechanism]

The circulation mechanism 5 is a mechanism for mainly circulating the ink 9 between the ink tanks 3 and the inkjet heads 4.

As shown in FIG. 3, the circulation mechanism 5 includes, for example, circulation channels 50 of the ink 9, pressure pumps 51a and suction pumps 51b.

The circulation channels 50 each include, for example, a first flow channel 50a through which the ink 9 flows from the ink tank 3 toward the inkjet head 4, and a second flow channel 50b through which the ink 9 flows from the inkjet head 4 toward the ink tank 3.

In each of the first flow channel 50a and the second flow channel 50b, for example, the ink 9 flows inside a tube, and the tube is, for example, a flexible tube having flexibility.

The pressure pump 51a is disposed in, for example, the first flow channel 50a. The pressure pump 51b pressurizes the inside of the first flow channel 50a. to thereby supply the inkjet head 4 with the ink 9.

The suction pump 51b is disposed in, for example, the second flow channel 50b. The suction pump 51b reduces the pressure of the inside of the second flow channel 50b to thereby suction the ink 9 from the inkjet head 4.

Thus, in the circulation mechanism 5, for example, the ink 9 flows toward a circulation direction F. Specifically, the ink 9 having supplied from the ink tank 3 flows through, for example, the first flow channel 50a, the inkjet head 4 and the second flow channel 50b in this order to thereby return to the ink tank 3.

### [Scanning Mechanism]

The scanning mechanism 6 is a mechanism for mainly making the inkjet head 4 perform a scanning operation in a direction (the Y-axis direction) crossing the carrying direction D.

As shown in FIG. 1, the scanning mechanism 6 includes, for example, a pair of guide rails 61a, 61b, a carriage 62 and a drive mechanism 63.

The guide rails 61a, 61b each extend in, for example, a direction (the Y-axis direction) crossing the carrying direction D. The carriage 62 is, for example, supported by the guide rails 61a, 61b, and capable of moving in a direction (the Y-axis direction) crossing the carrying direction D along the guide rails 61a, 61b. The drive mechanism 63 includes, for example, a pair of pulleys 631a, 631b, an endless belt 632, and a drive motor 633.

The pair of pulleys 631a, 631b are disposed between, for example, the guide rails 61a, 61b. The pulleys 631a, 631b are disposed at, for example, positions corresponding respectively to the vicinities of the both ends of the guide rails 61a, 61b so as to extend in the Y-axis direction. The belt 632 is wound between, for example, the pulleys 631a, 631b. The belt 632 is connected to, for example, the carriage 62, and on the carriage 62, there is mounted, for example, the inkjet head 4.

By using the carrying mechanisms 2a, 2b and the scanning mechanism 6 as a moving mechanism, the recording paper P and the inkjet head 4 can move relatively to each other.

### <1-2. Respective Detailed Configurations of Nozzle Plate, Actuator Plate and Cover Plate>

Then, the detailed configuration of each of the nozzle plate 41 the actuator plate 42, and the cover plate 43 will be described.

FIG. 4 shows respective perspective configurations of the nozzle plate 41, the actuator plate 42 and the cover plate 43 shown in FIG. 2. It should be noted that in FIG. 4, there is shown a state in which the nozzle plate 41, the actuator plate 42 and the cover plate 43 are separated from each other.

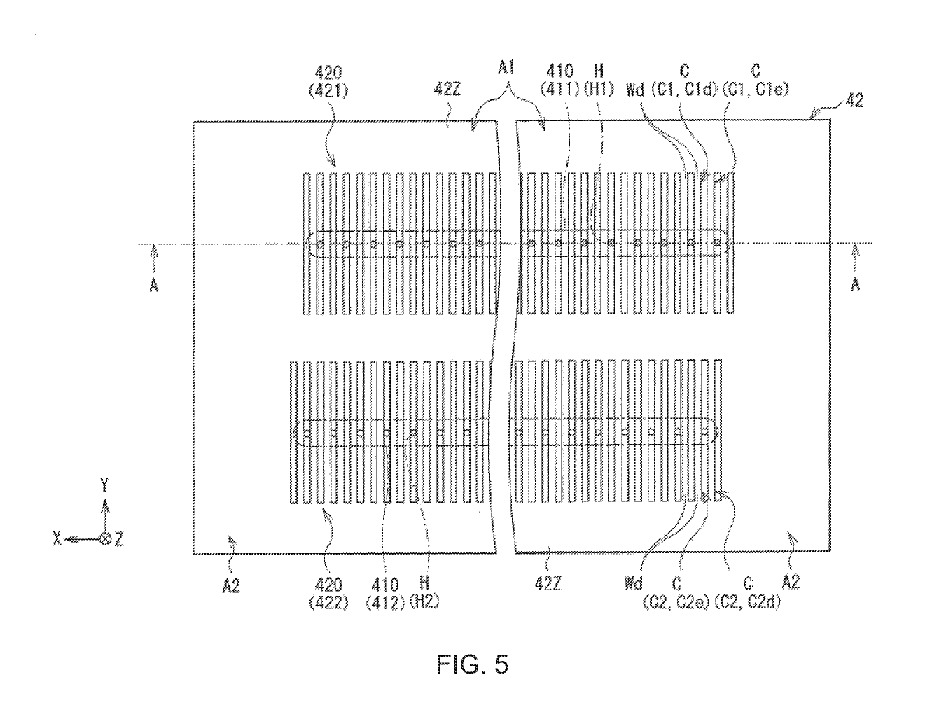

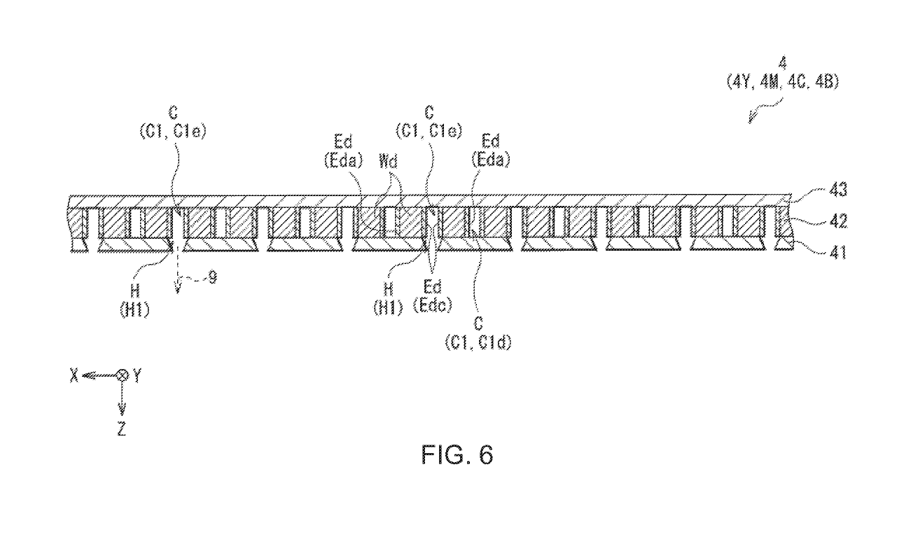

FIG. 5 shows a planar configuration of the actuator plate 42 shown in FIG. 4, and FIG. 6 shows respective cross sectional configurations of the nozzle plate 41, the actuator plate 42 and the cover plate 43 along the line A-A shown in FIG. 5.

It should be noted that in FIG. 5, nozzle columns 411, 412 (a plurality of nozzle holes H1, and a plurality of nozzle holes H2) are represented by dotted lines.

### [Nozzle Plate]

The nozzle plate 41 is a plate mainly provided with a plurality of nozzle holes H as a jet orifice of the ink 9 described later.

The nozzle plate 41 is attached to the actuator plate 42, and has a plurality of nozzle holes H at positions corresponding to a plurality of channels C (jet channels C1e, C2e).

Further, the nozzle plate 41 includes, for example, any one type or two or more types of insulating materials. The types of the insulating materials are not particularly limited, but are polymer materials such as polyimide. It should be noted that the nozzle plate 41 includes, for example, any one type or two or more types of conductive materials instead of the insulating materials. The types of the conductive materials are not particularly limited, but are metal materials such as stainless steel (SUS). The types of the stainless steel are not particularly limited, but are, for example, SUS316L and SUS304.

Specifically, the nozzle plate 41 has, for example, a plurality of nozzle columns 410 arranged at a predetermined distance in the Y-axis direction as shown in FIG. 4 through FIG. 6. The nozzle columns 410 each extend in, for example, the X-axis direction, and each include the plurality of nozzle holes H. The opening shape (the shape of the nozzle hole H viewed from the Z-axis direction) of the nozzle hole H is, for example, a circular shape.

Here, the nozzle plate 41 has, for example, two nozzle columns 410 (411, 412). Therefore, the inkjet head 4 is, for example, a so-called two-column type inkjet head.

The nozzle column 411 includes, for example, the plurality of nozzle holes H1 arranged at predetermined intervals in the X-axis direction. The nozzle holes H1 each extend in the Z-axis direction so as to penetrate the nozzle plate 41, and are communicated with the respective jet channels C1e of the actuator plate 42 described later. Further, the nozzle holes H1 are each located at a position corresponding to a roughly central area of the jet channel C1e extending in the Y-axis direction. The pitch (the distance between the two nozzle holes H1 adjacent to each other) of the plurality of nozzle holes H1 in the X-axis direction is substantially the same as, for example, the pitch (the distance between the two jet channels C1e adjacent to each other) of the jet channels C1e in the X-axis direction. Thus, the ink 9 supplied from the jet channels C1e is jetted from the respective nozzle holes H1.

The nozzle column 412 has substantially the same configuration as that of, for example, the nozzle column 411 described above. Specifically, the nozzle column 412 includes, for example, the plurality of nozzle holes H2 arranged at predetermined intervals in the X-axis direction. The nozzle holes H2 each penetrate the nozzle plate 41, and are communicated with the respective jet channels C2e of the actuator plate 42 described later. Further, the nozzle holes H2 are each located at a position corresponding to a roughly central area of the jet channel C2e extending in the Y-axis direction. The pitch (the distance between the two nozzle holes H adjacent to each other) of the plurality of nozzle holes H2 in the X-axis direction is substantially the same as, for example, the pitch (the distance between the two jet channels C2e adjacent to each other) of the plurality of jet channels C2e in the X-axis direction. Thus, the ink 9 supplied from the jet channels C2e is jetted from the respective nozzle holes H2.

The direction in which the ink 9 is jetted from each of the nozzle holes H1, H2 is the direction (the Z-axis direction) crossing the extending direction (the Y-axis direction) of the plurality of channels C as described above. More specifically, the jet direction of the ink 9 is a direction (the downward direction in FIG. 4) from the actuator plate 42 toward the nozzle plate 41. The inner diameter of each of the nozzle holes H1, H2 gradually decreases in a direction toward, for example, the jet direction. In other words, each of the nozzle holes H1, H2 is, for example, a penetration orifice having a tapered shape.

### [Actuator Plate]

The actuator plate 42 is a plate electrically operating mainly for jetting the ink 9 from the plurality of nozzle holes H.

As described above, the actuator plate 42 has the plurality of channels C each extending in the Y-axis direction. The opening shape (the shape of the channel C viewed from the Z-axis direction) of the channel C is, for example, a rectangular shape. By housing the ink 9 in each of the channels C, the ink 9 is jetted from each of the nozzles H.

Further, the actuator plate 42 includes, for example, any one type or two or more types of piezoelectric materials. The types of the piezoelectric materials are not particularly limited, but are, for example, lead zirconium titanate (PZT). The actuator plate 42 is, for example, a stacked body having two piezoelectric substrates stacked on one another, the two piezoelectric substrate being configured so that the respective polarization directions in the Z-axis direction are different from each other.

Specifically, the actuator plate 42 has, for example, a plurality of channel columns 420 arranged at a predetermined distance in the Y-axis direction as shown in FIG. 4 through FIG. 6. The channel columns 420 each extend in, for example, the X-axis direction, and each include the plurality of channels C. Here, the actuator plate 42 has, for example, the two channel columns 420 (421, 422).

In the actuator plate 42, for example, a jet area A1 of the ink 9 is disposed in roughly the central area (an area where the channel columns 421, 422 are formed) in the X-axis direction, and at the same time, non-jet areas A2 of the ink 9 are disposed in both end areas (the areas where the channel columns 421, 422 are not formed) in the X-axis direction. In other words, the non-jet areas A2 are disposed on the outer side of the jet area A1 in the X-axis direction. It should be noted that both end parts of the actuator plate 42 in the Y-axis direction are each a so-called tail part 42Z.

The channel column 421 includes, for example, a plurality of channels C1 extending in the Y-axis direction. The plurality of channels C1 is, for example, arranged at predetermined intervals in the X-axis direction. Each of the channels C1 is partitioned by, for example, drive walls Wd each including a piezoelectric body.

The channel column 422 has substantially the same configuration as that of, for example, the channel column 421 described above. Specifically, the channel column 422 includes, for example, a plurality of channels C2 extending in the Y-axis direction. The plurality of channels C2 is, for example, arranged at predetermined intervals in the X-axis direction. Each of the channels C2 is partitioned by, for example, the drive walls Wd each including a piezoelectric body.

The plurality of channels C1 includes, for example, the jet channels C1e for jetting the ink 9 and dummy channels C1d not jetting the ink 9. In the channel column 421, the jet channels C1e and the dummy channels C1d are alternately arranged along the X-axis direction, for example. The jet channels C1e are communicated with the respective nozzle holes H1 provided to the nozzle plate 41. In contrast, the dummy channels C1d are not communicated with the respective nozzle holes H1, but are shielded by the nozzle plate 41.

The plurality of channels C2 has substantially the same configuration as that of, for example, the plurality of channels C1 described above. Specifically, the plurality of channels C2 includes, for example, the jet channels C2e for jetting the ink 9 and dummy channels C2d not jetting the ink 9. In the channel column 422, the jet channels C2e and the dummy channels C2d are alternately arranged along the X-axis direction, for example. The jet channels C2e are communicated with the respective nozzle holes H2 provided to the nozzle plate 41. In contrast, the dummy channels C2d are not communicated with the respective nozzle holes H2, but are shielded by the nozzle plate 41.

The jet channels C1e and the dummy channels C1d, and the jet channels C2e and the dummy channels C2d are arranged in a staggered manner, for example. In other words, the jet channels C1e, C2e are arranged in a zigzag manner, for example. It should be noted that in the actuator plate 42, in each of the areas corresponding respectively to the dummy channels C1d, C2d, there is disposed, for example, a shallow groove section Dd. The shallow groove section Dd is communicated with an outside end part of each of the dummy channels C1d, C2d extending in the Y-axis direction, for example.

In the actuator plate 42, for example, drive electrodes Ed extending in the Y-axis direction are disposed on inner side surfaces opposed to the drive walls Wd. The drive electrodes Ed include, for example, common electrodes Edc disposed on the respective inner side surfaces of the ejection channels C1e, C2e, and active electrodes Eda disposed on the respective inner side surfaces of the dummy channels C1d, C2d. It should be noted that the drive electrodes Ed (the common electrodes Edc and the active electrodes Eda) each extend from one end part of the actuator plate 42 (the drive wall Wd) to the other end part in the Z-axis direction. Therefore, the dimension (the thickness) of the drive electrode Ed in the Z-axis direction is made roughly equal to, for example, the thickness of the drive wall Wd in the Z-axis direction.

The pair of common electrodes Edc opposed to each other inside one jet channel C1e (or one jet channel C2e) are, for example, electrically connected to each other via a common terminal. Further, the pair of active electrodes Eda opposed to each other inside one dummy channel C1d (or one dummy channel C2d) are, for example, electrically separated from each other. The pair of active electrodes Eda opposed to each other via the jet channel C1e (or the jet channel C2e) are, for example, electrically connected to each other via an active terminal.

In the tail part 42Z, for example, there is mounted a flexible printed circuit board 45 for electrically connecting the drive electrodes Ed and the inkjet head 4 to each other. It should be noted that in FIG. 4, outer edges (contours) of some parts of the flexible printed circuit board 45 are represented by the dotted lines. Interconnections provided to the flexible printed circuit board 45 are electrically connected to, for example, the common terminals and the active terminals described above, respectively. Thus, the drive voltage is applied to each of the drive electrodes Ed from the inkjet head 4 via the flexible printed circuit board 45.

### [Cover Plate]

The cover plate 43 is a plate for mainly introducing the ink 9 into the actuator plate 42 (the plurality of channels C), and at the same time discharging the ink 9 from the actuator plate 42.

The cover plate 43 includes, for example, substantially the same material as the constituent material of the actuator plate 42.

Specifically, as shown in FIG. 4 through FIG. 6, the cover plate 43 is disposed so as to shield the plurality of channels C1, C2 (the plurality of channel columns 421, 422) provided to the actuator plate 42.

The cover plate 43 has, for example, a pair of entrance side common ink chambers 431a, 432a and a pair of exit side common ink chambers 431b, 432b. The entrance side common ink chamber 431a and the exit side common ink chamber 431b are each disposed in, for example, an area corresponding to the channel column 421 (the plurality of channels C1) provided to the actuator plate 42. The entrance side common ink chamber 432a and the exit side common ink chamber 432b are each disposed in, for example, an area corresponding to the channel column 422 (the plurality of channels C2) provided to the actuator plate 42.

The entrance side common ink chamber 431a is disposed at a position corresponding to one end part (an inside end part) of each of the channels C1 extending in the Y-axis direction. In the entrance side common ink chamber 431a, in an area corresponding to each of the jet channels C1e, there is formed, for example, a supply slit Sa. Further, the entrance side common ink chamber 432a is disposed at a position corresponding to one end part (an inside end part) of each of the channels C2 extending in the Y-axis direction. In the entrance side common ink chamber 432a, in an area corresponding to each of the jet channels C2e, there is formed, for example, the supply slit Sa similarly to the entrance side common ink chamber 431a described above.

The exit side common ink chamber 431b is disposed at a position corresponding to the other end part (an outside end part) of each of the channels C1 extending in the Y-axis direction. In the exit side common ink chamber 431b, in an area corresponding to each of the jet channels C1e, there is formed, for example, a discharge slit Sb. Further, the exit side common ink chamber 432b is disposed at a position corresponding to the other end part (an outside end part) of each of the channels C2 extending in the Y-axis direction. In the exit side common ink chamber 432b, in an area corresponding to each of the jet channels C2e, there is formed, for example, the discharge slit Sb similarly to the exit side common ink chamber 431b described above.

The entrance side common ink chamber 431a and the exit side common ink chamber 431b are each communicated with each of the jet channels C1e via the supply slit Sa and the discharge slit Sb on the one hand, but are not communicated with each of the dummy channels C1d on the other hand. Specifically, each of the dummy channels C1d is shielded by the entrance side common ink chamber 431a and the exit side common ink chamber 431b.

The entrance side common ink chamber 432a and the exit side common ink chamber 432b are each communicated with each of the jet channels C2e via the supply slit Sa and the discharge slit Sb on the one hand, but are not communicated with each of the dummy channels C2d on the other hand. Specifically, each of the dummy channels C2d is shielded by the entrance side common ink chamber 432a and the exit side common ink chamber 432b.

### <1-3. Detailed Configuration of Flow Channel Plate>

Then, the detailed configuration of the flow channel plate 44 will be described.

### [Physicality of Flow Channel Plate]

The flow channel plate 44 is higher in rigidity than the head chip 400. The “rigidity” described here is a property of being hard to be bent in accordance with the external force (the force externally supplied to the flow channel plate 44).

The rigidity of each of the flow channel plate 44 and the head chip 400 is determined based on, for example, the rigidity of the constituent material itself and the shape. The “shape” denotes a variety of parameters for determining the three-dimensional shape such as the thickness, presence or absence of a penetration part (e.g., a hole or a slit), the number of the penetration parts, presence or absence of a non-penetration part (e.g., a groove), and the number of the non-penetration parts.

The reason that the flow channel plate 44 is higher in rigidity than the head chip 400 is that the head chip 400 is fixed along the flow channel plate 44, and therefore, the head chip 400 becomes hard to be warped by the external force due to the high rigidity of the flow channel plate 44. Thus, it becomes easy to keep the flatness of the head chip 400, and therefore, the jet characteristic (the straightness related to the jet direction of the ink 9) of the ink 9 jetted from the plurality of nozzle holes H is improved.

It should be noted that a variety of factors due to the manufacturing process of the inkjet head 4 are conceivable as the factors of supplying external force to the head chip 400. Specifically, there can firstly be cited the case of heating an adhesive at high temperature in, for example, the process of bonding the head chip 400 and the flow channel plate 44 to each other via the adhesive. In this case, in particular, the larger the difference in linear expansion coefficient between the head chip 400 and the flow channel plate 44 is, the stronger the external force supplied to the head chip 400 becomes. Secondly, there can be cited the case of, for example, pressure bonding the flexible printed circuit board 45 to the head chip 400. Thirdly, there can be cited the case of, for example, forming the channels C in the formation process of the actuator plate 42.

In particular, it is preferable for the flow channel plate 44 to have the higher Young's modulus than the Young's modulus of the head chip 400. This is because if the flow channel plate 44 has the higher Young's modulus than the Young's modulus of the head chip 400, the head chip becomes stable and hard to be warped, and therefore, the jet characteristic of the ink 9 is stabilized.

Further, it is preferable for the flow channel plate 44 to have the linear expansion coefficient equal to or lower than the linear expansion coefficient of the head chip 400. In other words, it is preferable for the flow channel plate 44 to have the equivalent linear expansion coefficient to the linear expansion coefficient of the head chip 400, or to have the lower linear expansion coefficient than the linear expansion coefficient of the head chip 400. This is because if the flow channel plate 44 has the linear expansion coefficient equal to or lower than the linear expansion coefficient of the head chip 400, the head chip 400 is prevented from deforming with the flow channel plate 44 due to the thermal deformation of the flow channel plate 44 when the head chip 400 and the flow channel plate 44 are each heated. Thus, the head chip 400 is made stable and hard to be warped, and therefore, the jet characteristic of the ink 9 is stabilized.

Here, the Young's modulus of the flow channel plate 44 can arbitrarily be set in accordance with the material (the constituent material) of the head chip 400. Specifically, in the case in which, for example, the head chip 400 includes lead zirconium titanate (PZT), it is preferable for the Young's modulus of the flow channel plate 44 to be equal to or higher than 60 GPa. This is because if the Young's modulus of the flow channel plate 44 is equal to or higher than 60 GPa, the head chip 400 becomes sufficiently hard to be warped due to the rigidity (the Young's modulus) of the flow channel plate 44 in the case in which the head chip 400 includes lead zirconium titanate, and therefore, it is possible to obtain excellent jet characteristic of the ink 9.

Further, the linear expansion coefficient of the flow channel plate 44 can arbitrarily be set in accordance with the material of the head chip 400. Specifically, in the case in which, for example, the head chip 400 includes lead zirconium titanate, it is preferable for the linear expansion coefficient of the flow channel plate 44 to be equal to or lower than 10×10⁻⁶/° C. This is because if the linear expansion coefficient of the flow channel plate 44 is equal to or lower than 10×10⁻⁶/° C., the head chip 400 becomes sufficiently hard to be warped due to the rigidity (the linear expansion coefficient) of the flow channel plate 44 in the case in which the head chip 400 includes lead zirconium titanate, and therefore, it is possible to obtain excellent jet characteristic of the ink 9.

The flow channel plate 44 includes one type or two or more types of high rigidity materials in order to ensure, for example, the Young's modulus and the linear expansion coefficient described above. The “high rigidity material” is a collective term for the materials having high rigidity. The types of the high rigidity materials are not particularly limited, but are, for example, borosilicate grass, quartz grass, aluminum oxide and thermoset resin. This is because if the flow channel plate 44 includes the high rigidity material, the head chip 400 becomes harder to be warped in the case in which the head chip 400 includes lead zirconium titanate, and therefore, it is possible to obtain the excellent jet characteristic.

It should be noted that the dielectric constant of the flow channel plate 44 is not particularly limited. In particular, it is preferable for the dielectric constant of the flow channel plate 44 to be sufficiently low, and more specifically, to be equal to or lower than 5 F/m. This is because if the dielectric constant of the flow channel plate 44 is equal to or lower than 5 F/m, the capacitance noise due to the physicality (the dielectric constant) of the flow channel plate 44 becomes difficult to occur, and therefore, the jet characteristic of the ink 9 is further improved.

Here, the physicality of the series of high rigidity materials described above is, for example, as follows. In borosilicate glass, the Young's modulus is about 64 GPa, the linear expansion coefficient is about 3.3×10⁻⁶/° C., and the dielectric constant is about 4 F/m. In quartz glass, the Young's modulus is about 72 GPa, the linear expansion coefficient is about 0.55×10⁻⁶/° C., and the dielectric constant is about 3.75 F/m. In aluminum oxide, the Young's modulus is about 360 GPa, the linear expansion coefficient is about 6×10⁻⁶/° C., and the dielectric constant is about 9.5 F/m.

Further, the thickness of the flow channel plate 44 is not particularly limited. In particular, it is preferable for the thickness of the flow channel plate 44 to be larger than the thickness of the head chip 400, and more specifically, to be equal to or larger than 2 mm. This is because if the thickness of the flow channel plate is equal to or larger than 2 mm, the rigidity of the flow channel plate 44 becomes high.

### [Configuration of Flow Channel Plate]

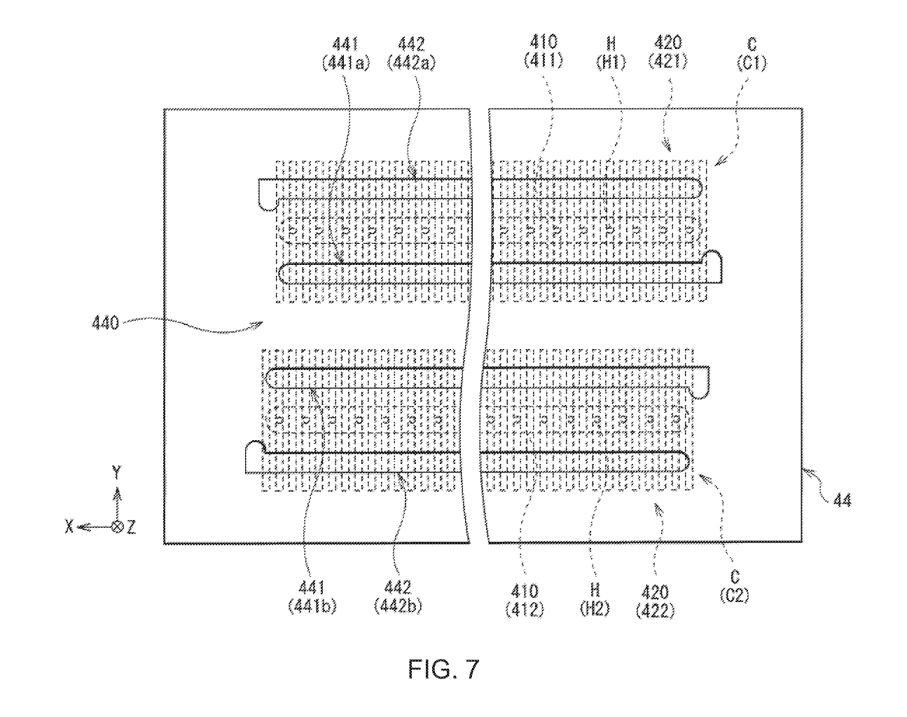

FIG. 7 shows a planar configuration of the flow channel plate 44 shown in FIG. 2.

It should be noted that in FIG. 7, the plurality of nozzle holes H (H1, H2), the plurality of nozzle columns 410 (411, 412), the plurality of channels C (C1, C2) and the plurality of channel columns 420 (421, 422) are represented by the dotted lines in order to make the positional relationship between the nozzle plate 41 and the flow channel plate 44 easy to understand.

The flow channel plate 44 has flow channels 440 of the ink 9 to be supplied to the plurality of channels C as shown in, for example, FIG. 7. The flow channels 440 are penetrating grooves for transmitting the ink 9, and extend in substantially the same direction (the X-axis direction) as the extending direction of the channel columns 421, 422.

In particular, the flow channels 440 have, for example, a plurality of introduction flow channels 441 and a plurality of discharge flow channels 442 for transmitting the ink 9. Specifically, the flow channels 440 include, for example, the introduction flow channel 441a and the discharge flow channel 442a disposed at positions corresponding to the channel column 421, and the introduction flow channel 441b and the discharge flow channel 442b disposed at positions corresponding to the channel column 422. This is because if the flow channel 440 has the plurality of introduction flow channels 441 and the plurality of discharge flow channels 442, it becomes difficult for a pressure wave generated due to jetting of the ink 9 in the plurality of channels C1 included in the channel column 421 to reach the plurality of channels C2 included in the channel column 422 even if the pressure wave is actually generated, and therefore, the ink 9 is stably jetted from the plurality of nozzle holes Further, this is because if the flow channel 440 has the plurality of introduction flow channels 441 and the plurality of discharge flow channels 442, the total amount (the circulation amount) of the ink 9 in the flow channel 440 becomes larger compared to the case in which the flow channel 440 has a single introduction flow channel 441 and a single discharge flow channel 442, and therefore, the ink 9 high in viscosity is also circulated sufficiently and stably.

The introduction flow channel 441a and the discharge flow channel 442a are disposed so as to overlap the channel column 421. The introduction flow channel 441a is an introduction port for introducing the ink 9 into the plurality of channels C1, and at the same time, the discharge flow channel 442a is a discharge port for discharging the ink 9 from the plurality of channels C1. Therefore, the ink 9 is introduced into the plurality of channels C1 via the introduction flow channel 441a, and is then discharged from the plurality of channels C1 via the discharge flow channel 442a.

Since the nozzle column 411 is disposed between the introduction flow channel 441a and the discharge flow channel 442a, the introduction flow channel 441a and the discharge flow channel 442a are separated from each other in the Y-axis direction via the nozzle column 411. The introduction flow channel 441a is disposed, for example, on the inner side of the discharge flow channel 442a in the Y-axis direction.

The introduction flow channel 441b and the discharge flow channel 442b are disposed so as to overlap the channel column 422. The introduction flow channel 441b is an introduction port for introducing the ink 9 into the plurality of channels C2, and at the same time, the discharge flow channel 442b is a discharge port for discharging the ink 9 from the plurality of channels C2. Therefore, the ink 9 is introduced into the plurality of channels C2 via the introduction flow channel 441b, and is then discharged from the plurality of channels C2 via the discharge flow channel 442b.

Since the nozzle column 412 is disposed between the introduction flow channel 441b and the discharge flow channel 442b, the introduction flow channel 441b and the discharge flow channel 442b are separated from each other in the Y-axis direction via the nozzle column 412. The introduction flow channel 441b is disposed, for example, on the inner side of the discharge flow channel 442b in the Y-axis direction.

### <1-4. Operations=

Then, the operations of the printer 1 will be described.

### [Operations of Printer]

Firstly, an overall operation of the printer 1 will be described. In this printer 1, an image and so on are recorded on the recording paper P in the following procedure.

In the initial state, the ink 9 of the four colors (yellow, magenta, cyan and black) different from each other are respectively housed in the four ink tanks 3 (3Y, 3M, 3C and 3B). The ink 9 is circulated in the circulation mechanism 5 to thereby be supplied to the inkjet head 4.

When the printer 1 operates, the grit rollers 21 of the respective carrying mechanisms 2a, 2b rotate, and therefore, the recording paper P is carried in the carrying direction D due to the grit rollers 21 and the pinch rollers 22. In this case, due to the drive of the drive mechanism 63 (the drive motor 633), the pulleys 631a, 631b rotate to thereby operate the belt 632. Further, the carriage 62 reciprocates in the Y-axis direction using the guide rails 61a, 61b. Thus, since the four colors of ink 9 are jetted from the four inkjet heads 4 (4Y, 4M, 4C and 4B) to the recording paper P, the image and so on are recorded on the recording paper P.

### [Operations of Inkjet Heads]

Then, the operations of the inkjet heads 4 when the printer 1 is in operation will be described. In each of the inkjet heads 4, the ink 9 is jetted to the recording paper P using a shear mode in the following procedure.

Firstly, when the carriage 62 reciprocates, the drive voltages are applied to the drive electrodes Ed (the common electrodes Edc and the active electrodes Eda) in the inkjet head 4 via the flexible printed circuit board 45. Specifically, the drive voltage is applied to the respective drive electrodes Ed provided to the pair of drive walls Wd defining each of the jet channels C1e, C2e. Thus, the pair of drive walls Wd each deform so as to protrude toward the dummy channel C1d, C2d adjacent to the ejection channel C1e, C2e.

Here, as described above, in the actuator plate 42, the two piezoelectric substrates configured so that the polarization directions in the Z-axis direction are different from each other are stacked on one another, and at the same time, the drive electrodes Ed extend in the Z-axis direction from one end part of the drive walls Wd to the other end part. In this case, by applying the drive voltage to the drive electrodes Ed, the drive wall Wd makes flexural deformation taking a roughly middle position of the drive wall Wd in the Z-axis direction as an origination due to the piezoelectric thickness-shear effect. Thus, each of the jet channels C1e, C2e deforms as if it bulges using the flexural deformation of the drive wall Wd described above.

Meanwhile, as described above, in the cover plate 43 and the flow channel plate 44, when the ink 9 flows from the introduction flow channel 441a toward the discharge flow channel 442a, the ink 9 is supplied to the entrance side common ink chamber 431a, and is therefore retained in the entrance side common ink chamber 431a. Further, when the ink 9 flows from the introduction flow channel 441b toward the discharge flow channel 442b, the ink 9 is supplied to the entrance side common ink chamber 432a, and is therefore retained in the entrance side common ink chamber 432a.

The capacity of each of the jet channels C1e, C2e increases using the flexural deformation of the pair of drive walls Wd based on the piezoelectric thickness-shear effect described above. Thus, the ink 9 having retained in each of the entrance side common ink chambers 431a, 432a is induced into the inside of each of the jet channels C1e, C2e.

Subsequently, the ink 9 having been induced into the inside of each of the jet channels C1e, C2e propagates to the inside of each of the jet channels C1e, C2e as a pressure wave. In this case, the drive voltage to be applied to the drive electrodes Ed becomes zero (0 V) at the timing at which the pressure wave has reached the nozzle hole H1, H2 provided to the nozzle plate 41. Thus, the drive walls Wd having flexurally deformed are restored to the original state, and therefore, the capacity of each of the jet channels C1e, C2e is restored.

Lastly, when the capacity of each of the jet channels C1e, C2e is restored, the pressure increases in the inside of each of the jet channels C1e, C2e, and therefore, the ink 9 having been induced into the inside of each of the jet channels C1e, C2e is pressurized. Thus, the ink 9 shaped like a droplet is jetted from the nozzle holes H1, H2 toward the outside (the recording paper P).

In this case, for example, since the inner diameter of each of the nozzle holes H1, H2 gradually decreases toward the jet direction as described above, the jet speed of the ink 9 increases, and at the same time, the straightness of the ink 9 is improved. Thus, the quality of the image and so on recorded on the recording paper P is improved.

### <1-5. Functions and Advantages>

Lastly, the functions and the advantages of the printer 1 equipped with the inkjet heads 4 will be described.

[Principal Functions and Advantages]

In the printer 1, the flow channel plate 44 has the higher rigidity than that of the head chip 400 in the inkjet head 4, and the flow channel plate 44 is fixed along the head chip 400. Therefore, due to the grounds described below, it is possible to stably manufacture the printer 1 equipped with the inkjet heads 4 having the excel lent jet characteristic.

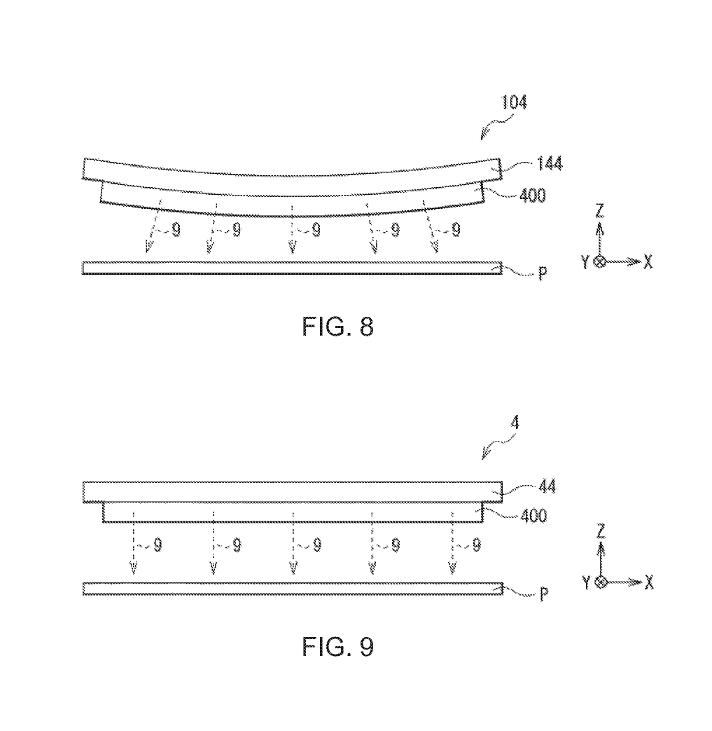

FIG. 8 shows a planar configuration corresponding to FIG. 2 in order to explain a configuration and problems of a printer (an inkjet head 104) of a comparative example. FIG. 9 shows a planar configuration corresponding to FIG. 2 in order to explain advantages of the printer 1 (the inkjet head 4) according to the present embodiment. It should be noted that in each of FIG. 8 and FIG. 9, the illustration of the inkjet head 4 is simplified, and at the same time, the recording paper P Is also shown.

The inkjet head 104 of the comparative example has substantially the same configuration as that of the inkjet head 4 according to the present embodiment except the fact that a flow channel plate 144 is provided instead of the flow channel plate 44. The flow channel plate 144 has substantially the same configuration of the flow channel plate 44 except the fact that the lower rigidity than that of the head chip 400 is provided.

In the printer of the comparative example, when the external force described above is applied to the head chip 400 in the manufacturing process of the inkjet head 104, the head chip 400 becomes apt to deform together with the flow channel plate 144 as shown in FIG. 8. Specifically, since each of the head chip 400 and the flow channel plate 144 warps so that, for example, a central part in the X-axis direction comes closer to the recording paper P, the flatness of the head chip 400 becomes difficult to maintain. It should be noted that although not specifically illustrated here, each of the head chip 400 and the flow channel plate 144 warps so that the central part in the X-axis direction gets away from the recording paper P in some cases.

If the head chip 400 warps, the straightness of the ink 9 deteriorates due to the fact that the deflection occurs with respect to the jet direction of the ink 9 after the completion of the inkjet head 104, and therefore, the jet position of the ink 9 relative to the recording paper P becomes apt to be shifted from the desired position. Therefore, it is difficult to stably manufacture the printer equipped with the inkjet head 104 having the excellent jet characteristic since it is difficult to improve the jet characteristic of the ink 9, and at the same time, the fabrication yield of the inkjet head 104 decreases. In this case, in particular, the jet characteristic of the ink 9 is insufficient, and therefore, due to the displacement of the jet position described above, the quality of the image formed using the printer becomes apt to degrade.

It should be noted that in the case in which the head chip 400 is supported by a base as a support member, it is conceivable to clamp the head chip 400 between the base and the flow channel plate 144 to thereby correct the warp of the head chip 400. In this case, by pressing the head chip 400 against the flow channel plate 144 using the base, the head chip 400 is forcibly made difficult to deform.

However, in the case of correcting the warp of the head chip 400 using the base, due to the force for pressing the base against the head chip 400 described above, unwanted stress becomes apt to remain inside the head chip 400. In this case, since a crack becomes apt to occur in the head chip 400 due to a change in temperature or the like, the head chip 400 becomes easy to be damaged. Therefore, also in the viewpoint that the head chip 400 becomes easy to be damaged due to the unwanted stress, it is difficult to manufacture the printer equipped with the inkjet head 104 having the excellent jet characteristic.

In contrast, in the inkjet head 4 according to the present embodiment, as described above, the flow channel plate 44 having the high rigidity is fixed along the head chip 400. In this case, even if the external force is applied to the head chip 400 in the manufacturing process of the inkjet head 4, the head chip 400 becomes difficult to deform together with the flow channel plate 44 as shown in FIG. 9. Specifically, since each of the head chip 400 and the flow channel plate 44 becomes difficult to warp, the flatness of the head chip 400 becomes apt to be maintained.

Thus, the straightness of the ink 9 is improved due to the fact that the deflection becomes difficult to occur with respect to the jet direction of the ink 9 after the completion of the inkjet head 4, and therefore, the jet position of the ink 9 relative to the recording paper P becomes apt to coincide with the desired position. Therefore, it is possible to stably manufacture the printer 1 equipped with the inkjet heads 4 having the excellent jet characteristic since the jet characteristic of the ink 9 is improved, and at the same time, the fabrication yield of the inkjet head 4 also increases. In this case, in particular, the jet characteristic of the ink 9 is improved, and therefore, the quality of the image formed using the printer 1 is also improved.

In this case, since it becomes difficult for the unwanted stress to remain inside the head chip 400 clue to the fact that the head chip 400 becomes difficult to warp without using the pressing force of the base, it becomes difficult for the crack to occur in the head chip 400. Therefore, it is possible to stably manufacture the inkjet head 4 having the jet characteristic also superior in the viewpoint that the head chip 400 becomes difficult to be damaged.

### [Other Functions and Advantages]

In particular, in the printer 1 according to the present embodiment, if the flow channel plate 44 has the higher Young's modulus than the Young's modulus of the head chip 400, the head chip 400 becomes stable and hard to be warped, and therefore, a greater advantage can be obtained.

Further, if the flow channel plate 44 has the linear expansion coefficient equal to or lower than the linear expansion coefficient of the head chip 400, the head chip 400 becomes stable and hard to be warped in the case in which each of the head chip 400 and the flow channel plate 44 is heated, and therefore, it is possible to obtain a greater advantage.

Further, if the head chip 400 includes lead zirconium titanate, and at the same time, the Young's modulus of the flow channel plate 44 is equal to or higher than 60 GPa, the head chip 400 becomes sufficiently hard to be warped using the rigidity (the Young's modulus) of the flow channel plate 44 in the case in which the head chip 400 includes lead zirconium titanate, and therefore, a greater advantage can be obtained.

Further, if the head chip 400 includes lead zirconium titanate, and at the same time, the linear expansion coefficient of the flow channel plate 44 is equal to or lower than 10×10⁻⁶/° C., the head chip 400 becomes sufficiently hard to be warped using the rigidity (the linear expansion coefficient) of the flow channel plate 44 in the case in which the head chip 400 includes lead zirconium titanate, and therefore, a greater advantage can be obtained.

Further, if the flow channel plate 44 includes borosilicate glass or the like as the high rigidity material, the head chip 400 becomes harder to be warped in the case in which the head chip 400 includes lead zirconium titanate, and therefore, it is possible to obtain a greater advantage.

Further, if the dielectric constant of the flow channel plate 44 is equal to or lower than 5 F/m, the jet characteristic of the ink 9 is further improved due to the fact that the capacitance noise caused by the physicality (the dielectric constant) of the flow channel plate 44 becomes difficult to occur, and therefore, a greater advantage can be obtained.

Further, if the actuator plate 42 has the channel columns 421, 422, and the flow channel plate 44 (the flow channel 440) includes the introduction flow channel 441a and the discharge flow channel 442a corresponding to the channel column 421, and the introduction flow channel 441b and the discharge flow channel 442b corresponding to the channel column 422, even if the pressure wave due to jetting of the ink 9 occurs in the channel column 421 (the plurality of channels C1), the pressure wave becomes difficult to reach the channel column 422 (the plurality of channels C2). Therefore, since the ink 9 is stably jetted from the plurality of nozzle holes H, a greater advantage can be obtained.

It should be noted that the functions and the advantages related to the printer 1 described above can also be obtained with respect to the inkjet head 4 in a similar manner.

### 2. MODIFIED EXAMPLES

The configuration of the printer 1 (the inkjet head 4) described above can arbitrarily be changed. It should be noted that regarding the series of modified examples described below, any two or more types can also be combined with each other.

### Modified Example 1

The number of the nozzle columns 410 provided to the nozzle plate 41 is not limited to two, but can arbitrarily be changed, and at the same time, the number of the channel columns 420 provided to the actuator plate 42 is not limited to two, but can arbitrarily be changed. In this case, the number of the introduction flow channels 441 and the number of the discharge flow channels 442 provided to the flow channel plate 44 can also be changed in accordance with the number of the nozzle columns 410 and the number of the channel columns 420.

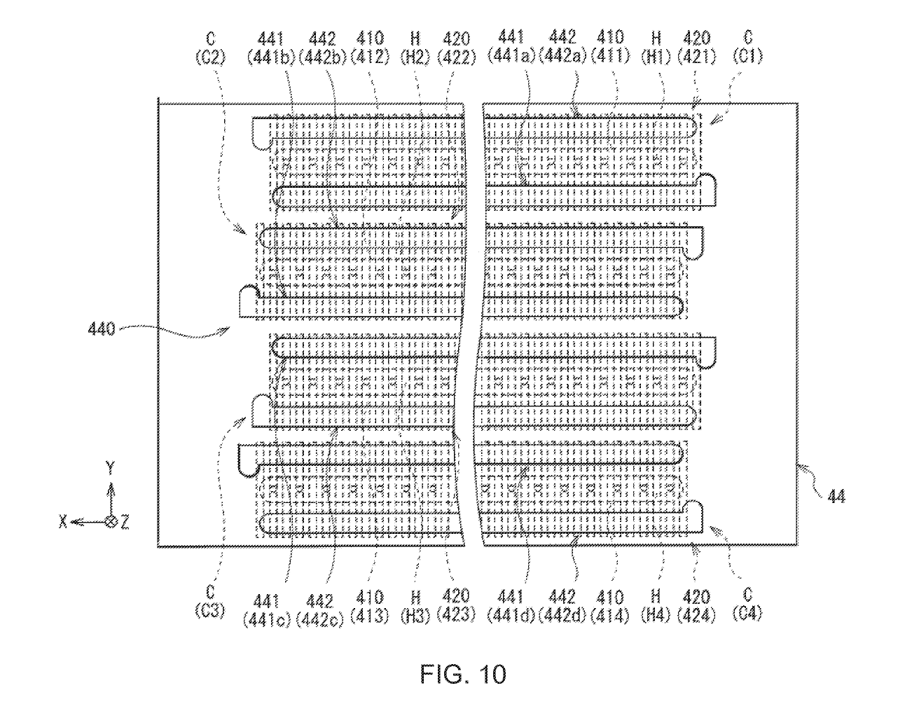

Specifically, for example, as shown in FIG. 10 corresponding to FIG. 7, it is also possible to change the number of the introduction flow channels 441 and the number of the discharge flow channel 442 to four by changing the number of the nozzle columns 410 to four.

Specifically, the nozzle plate 41 has, for example, the four nozzle columns 410 (411, 412, 413 and 414). The nozzle column 411 includes the plurality of nozzle holes H (H1), the nozzle column 412 includes the plurality of nozzle holes H (H2), the nozzle column 413 includes the plurality of nozzle holes H (H3), and the nozzle column 414 includes the plurality of nozzle holes H (H4).

The actuator plate 42 has the four channel columns 420 (421, 422, 423 and 424). The channel column 421 includes the plurality of channels C (C1), the channel column 422 includes the plurality of channels C (C2), the channel column 423 includes the plurality of channels C (C3), and the channel column 424 includes the plurality of channels C (C4).

The flow channel 440 includes, for example, the introduction flow channel 441a and the discharge flow channel 442a corresponding to the channel column 421, the introduction flow channel 441b and the discharge flow channel 442b corresponding to the channel column 422, an introduction flow channel 441c and a discharge flow channel 442c corresponding to the channel column 423, and an introduction flow channel 441d and a discharge flow channel 442d corresponding to the channel column 424. The functions and the configuration of each of the introduction flow channels 441c, 441d are substantially the same as the functions and the configuration of each of the introduction flow channels 441a, 441b, and at the same time, the functions and the configuration of each of the discharge flow channels 442c, 442d are substantially the same as the functions and the configuration of each of the discharge flow channels 442a, 442b.

The ink 9 is introduced into the plurality of channels C1 via the introduction flow channel 441a, and is then discharged from the plurality of channels C1 via the discharge flow channel 442a. Further, the ink 9 is introduced into the plurality of channels C2 via the introduction flow channel 441b, and is then discharged from the plurality of channels C2 via the discharge flow channel 442b. Further, the ink 9 is introduced into the plurality of channels C3 via the introduction flow channel 441c, and is then discharged from the plurality of channels C3 via the discharge flow channel 442c. Further, the ink 9 is introduced into the plurality of channels C4 via the introduction flow channel 441d, and is then discharged from the plurality of channels C4 via the discharge flow channel 442d.

Also in this case, for example, since the pressure wave generated due to jetting of the ink 9 in an arbitrary channel column 420 (e.g., the channel column 421) becomes difficult to reach the other channel columns 420 (e.g., the channel columns 422, 423 and 424), it is possible to obtain substantially the same advantages.

Needless to add, the number of the nozzle columns 410 and the number of the channel columns 420 are not limited to two and four, and can therefore be three, or five or more. Due to the above, the number of the introduction flow channels 441 and the number of the discharge flow channels are not limited to two and four, and can therefore be three, or five or more.

### Modified Example 2

Besides the above, the types and so on of each of the printer 1 and the inkjet head 4 can arbitrarily be changed. Further, the shape, the layout, the number and so on related to the series of constituents of each of the printer 1 and the inkjet head 4 can arbitrarily be changed.

Specifically, for example, although there has been described the case in which each of the nozzle columns 411, 412 extends in the X-axis direction, this is not a limitation, and it is also possible for each of the nozzle columns 411, 412 to extend in an oblique direction with respect to the X-axis direction, or to extend in other directions. It should be noted that, for example, although there has been described the case in which the opening shape of each of the nozzle holes H1, H2 is the circular shape, this is not a limitation, and the opening shape of each of the nozzle holes H1, H2 can also he a roughly circular shape such as an elliptical shape, a polygonal shape such as a triangular shape, or other shapes.

### Modified Example 3

Further, for example, it is also possible to add a variety of mechanisms to the printer 1. Specifically, for example, it is also possible to install a wiping mechanism and so on not shown in the drawings to the printer 1. The wiping mechanism is, for example, a mechanism having a function of removing the ink 9 having adhered to the surface (the nozzle surface) of the nozzle plate 41 provided with the nozzle holes H.

Although the description regarding the present disclosure has been presented hereinabove citing the embodiment, the configuration of the present disclosure is not limited to the configuration explained in the embodiment described above, but a variety of modifications can be adopted.

Specifically, for example, instead of jetting a single color of ink from a single inkjet head, it is also possible for the single inkjet head to jet a plurality of colors (e.g., two colors) of ink different from each other.

Further, for example, the inkjet head is not limited to the side-shoot type inkjet head, but can also be an edge-shoot type inkjet head. In the edge-shoot type inkjet head, each of the channels provided to the actuator plate extends in the Y-axis direction, and the ink is jetted in the Y-axis direction from each of the nozzle holes provided to the nozzle plate.

Further, for example, the inkjet printer is not limited to the ink circulation type inkjet printer using the circulation mechanism, but can also be an ink non-circulation type inkjet printer not using the circulation mechanism.

Further, for example, the purposes to which each of the liquid jet head and the liquid jet recording device of the present disclosure is applied are not limited to the inkjet printer, but can also be other purposes. The other purposes can also be other devices such as a facsimile or an on-demand printing machine.

It should be noted that the advantages described in the specification are illustrative only but are not a limitation, and other advantages can also be provided.

Further, the present disclosure can also take the following configurations.

<1>

A liquid jet head comprising a head chip including an actuator plate having a plurality of channels which is filled with liquid, and a nozzle plate attached to the actuator plate and having a plurality of nozzle holes from which the liquid filled in the plurality of channels is jetted; and a flow channel member fixed along the head chip, having a flow channel of the liquid to be supplied to the plurality of channels, and being higher in rigidity than the head chip.

<2>

The liquid jet head according to <1>, wherein the flow channel member has a higher Young's modulus than a Young's modulus of the head chip.

<3>

The liquid jet head according to <1> or <2>, wherein the flow channel member has a linear expansion coefficient one of equal to and lower than a linear expansion coefficient of the head chip.

<4>

The liquid jet head according to any one of <1> to <3>, wherein the head chip includes lead zirconium titanate, and the Young' modulus of the flow channel member is no smaller than 60 GPa.

<5>

The liquid jet head according to any one of <1> to <4>, wherein the head chip includes lead zirconium titanate, and the linear expansion coefficient of the flow channel member is no higher than 10×10⁻⁶/° C.

<6>

The liquid jet head according to <4> or <5>, wherein the flow channel member includes at least one of borosilicate glass, quartz glass, aluminum oxide and thermoset resin.

<7>

The liquid jet head according to any one of <1> to <6>, wherein a dielectric constant of the flow channel member is no higher than 5 F/m.

<8>

The liquid jet head according to any one of <1> to <7>, wherein the actuator plate has a plurality of channel columns having the plurality of channels arranged, and the flow channel includes a plurality of introduction flow channels disposed at positions corresponding respectively to the plurality of channel columns, and adapted to introduce the liquid into the plurality of channels included in the respective channel columns, and a plurality of discharge flow channels disposed at positions corresponding respectively to the plurality of channel columns, and adapted to discharge the liquid from the plurality of channels included in the respective channel columns.

<9>

A liquid jet recording device comprising the liquid jet head according to any one of <1> to <8>, and adapted to jet the liquid to a recording target medium; and a liquid storage section adapted to store the liquid.

What is claimed is:

1. A liquid jet head comprising:
a head chip including an actuator plate having a plurality of channels which is filled with liquid, and a nozzle plate attached to the actuator plate and having a plurality of nozzle holes from which the liquid filled in the plurality of channels is jetted; and
a flow channel member fixed along the head chip, having a flow channel of the liquid to be supplied to the plurality of channels, and being higher in rigidity than the head chip.

2. The liquid jet head according to claim 1, wherein
the flow channel member has a higher Young's modulus than a Young's modulus of the head chip.

3. The liquid jet head according to claim 1, wherein
the flow channel member has a linear expansion coefficient one of equal to and lower than a linear expansion coefficient of the head chip.

4. The liquid jet head according to claim 1, wherein
the head chip includes lead zirconium titanate, and
the Young' modulus of the flow channel member is no smaller than 60 GPa.

5. The liquid jet head according to claim 1, wherein
the head chip includes lead zirconium titanate, and
the linear expansion coefficient of the flow channel member is no higher than 10×10⁻⁶/° C.

6. The liquid jet head according to claim 4, wherein
the flow channel member includes at least one of borosilicate glass, quartz glass, aluminum oxide and thermoset resin.

7. The liquid jet head according to claim 1, wherein
a dielectric constant of the flow channel member is no higher than 5 F/m.

8. The liquid jet head according to claim 1, wherein
the actuator plate has a plurality of channel columns having the plurality of channels arranged, and
the flow channel includes
a plurality of introduction flow channels disposed at positions corresponding respectively to the plurality of channel columns, and adapted to introduce the liquid into the plurality of channels included in the respective channel columns, and
a plurality of discharge flow channels disposed at positions corresponding respectively to the plurality of channel columns, and adapted to discharge the liquid from the plurality of channels included in the respective channel columns.

9. A liquid jet recording device comprising:
the liquid jet head according to claim 1, and adapted to jet the liquid to a recording target medium; and
a liquid storage section adapted to store the liquid.
